(19) United States
(12) Patent Application Publication
(10) Pub. No.: US 2023/0383072 A1
(43) Pub. Date: Nov. 30, 2023

(54) POROUS FILM AND METHOD FOR MANUFACTURING THE SAME

(71) Applicant: Beyond Manufacture Inc., New Taipei City (TW)

(72) Inventors: Chun-Hao Luo, New Taipei City (TW); Ren-Yu Liao, Taichung City (TW)

(21) Appl. No.: 17/887,524

(22) Filed: Aug. 15, 2022

(30) Foreign Application Priority Data
May 25, 2022 (TW) 111119377

(51) Int. Cl. C08J 5/18; C08J 9/228

(52) U.S. Cl. CPC C08J 5/18; C08J 9/228; C08J 2201/0504; C08J 2205/044

(57) ABSTRACT

A porous film and a method for manufacturing the same are provided. The method includes: using a ternary mixed solvent to dissolve a structural material selected from the group consisting of nitrocellulose, polyvinylidene fluoride, polysulfone, and any combination thereof and an auxiliary structural material selected from the group consisting of cellulose acetate, polylactic acid, poly(lactic-co-glycolic acid), poly-(D)glucosamine, and any combination thereof, so as to obtain a mixed solution; adding water into the mixed solution to obtain a film-forming solution; coating the film-forming solution onto a carrier substrate to form a wet film; and vaporizing the ternary mixed solvent and the water to form the porous film on the carrier substrate. The ternary mixed solvent, based on a total weight thereof being 100 phr, includes 28 phr to 38 phr of ethanol, 25 phr to 42 phr of isopropanol, and 25 phr to 40 phr of acetone.

### CROSS-REFERENCE TO RELATED PATENT APPLICATION

This application claims the benefit of priority to Taiwan Patent Application No. 111119377, filed on May 25, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a porous film and a method for manufacturing the same, and more particularly to a porous film that is used for filtering or rapid testing and a method for manufacturing the same.

### BACKGROUND OF THE DISCLOSURE

In order to be applicable in the field of filtering and rapid testing, it is necessary for porous films on the market to have a uniform thickness and a uniform porous structure. Such uniformities can reduce discrepancies between (e.g., the results of) each operation or use, so as to achieve the effect of standardized testing.

Conventional porous films that are currently available on the market can have issues of not being uniform in thickness and porous structure. After being tested by a film dispenser, strips formed on the porous film are not uniform in thickness and are not continuous, with breakpoints being formed in the middle.

When the conventional porous film is applied in a rapid test structure, the accuracy of test results can be negatively affected when the thickness and the porous structure are not uniform. For example, when the porous structure of the porous film is loose, a liquid thereon has a faster flow speed, and analytes have a shorter combination time. As a result, analytes that are captured can be limited in quantity, and color-developed strips (which are known as a control line and a test line on a test strip) can fail to accurately develop color, which may result in false readout such as false negatives. When the porous structure of the porous film is dense, the liquid thereon has a slower flow speed. As a result, a length of time for the analytes and impurities to deposit or to be retained on the porous structure becomes longer, which may result in false positives in testing. Therefore, when the porous structure of the porous film is not uniform (some areas being loose in structure, and some areas being dense in structure), analysis results are prone to be erroneous.

Therefore, how to form a porous film that has a uniform thickness and a uniform porous structure, so as to overcome the above-mentioned problems, has become one of the important issues to be solved in the industry.

### SUMMARY OF THE DISCLOSURE

In response to the above-referenced technical inadequacies, the present disclosure provides a porous film and a method for manufacturing the same.

In one aspect, the present disclosure provides a method for manufacturing a porous film. The method includes the following steps: using a ternary mixed solvent to dissolve a structural material and an auxiliary structural material, so as to obtain a mixed solution; adding water into the mixed solution to obtain a film-forming solution; coating the film-forming solution onto a carrier substrate to form a wet film; and vaporizing the ternary mixed solvent and the water to form the porous film on the carrier substrate. Based on a total weight of the ternary mixed solvent being 100 phr, the ternary mixed solvent includes 28 phr to 38 phr of ethanol, 25 phr to 42 phr of isopropanol, and 25 phr to 40 phr of acetone. The structural material is selected from the group consisting of nitrocellulose, polyvinylidene fluoride, polysulfone, and any combination thereof. The auxiliary structural material is selected from the group consisting of cellulose acetate, polylactic acid, poly(lactic-co-glycolic acid), poly-(D)glucosamine, and any combination thereof.

In certain embodiments, the step of using the ternary mixed solvent to dissolve the structural material includes: sequentially adding the ethanol, the isopropanol, and the acetone to form the ternary mixed solvent.

In certain embodiments, an added amount of the water is 0.5 to 5 times a weight of the structural material.

In certain embodiments, the step of vaporizing the ternary mixed solvent and the water includes: vaporizing a portion of the ternary mixed solvent at a temperature from 40° C. to lower than 50° C., so that water molecules are assembled by phase separation to form drops; and vaporizing another portion of the ternary mixed solvent and the water at a temperature from 50° C. to 65° C., so as to form the porous film.

In certain embodiments, a total solvent includes the ternary mixed solvent and the water. Based on a total weight of the total solvent being 100 wt %, 60 wt % to 80 wt % of the total solvent is vaporized at a temperature from 40° C. to lower than 50° C.

In certain embodiments, based on a total weight of the ternary mixed solvent and the water being 100 phr, an added amount of the ethanol ranges from 25 phr to 32 phr, an added amount of the isopropanol ranges from 20 phr to 40 phr, and an added amount of the acetone ranges from 25 phr to 32 phr.

In certain embodiments, the step of adding the water into the mixed solution includes: mixing a hydrophilic material with the water to form a modifying solution, and then adding the modifying solution into the mixed solution.

In certain embodiments, a viscosity of the film-forming solution ranges from 150 cps to 900 cps.

In certain embodiments, based on a total weight of the film-forming solution being 100 phr, an amount of the structural material ranges from 5 phr to 15 phr, an amount of the auxiliary structural material ranges from 0.5 phr to 5 phr, an amount of the ternary mixed solvent ranges from 80 phr to 95 phr, and an amount of the water ranges from 5 phr to 18 phr.

In certain embodiments, the carrier substrate can be a polyethylene terephthalate (PET) film, a poly(ethylene) (PE) film, a poly(propylene) (PP) film, an aluminum (Al) foil, or a substrate that carries the same.

In certain embodiments, the carrier substrate can be a polyethylene terephthalate (PET) release film, a poly(ethylene) (PE) release film, a poly(propylene) (PP) release film, or an aluminum (Al) foil release film. The method further includes: separating the porous film from the carrier substrate after the porous film is formed.

In another aspect, the present disclosure provides a porous film. The porous film is manufactured by the above-mentioned method, and a thickness uniformity of the porous film is less than or equal to ±10%.

In certain embodiments, a pore size of the porous film is between 2 micrometers and 20 micrometers.

In certain embodiments, a porosity of the porous film ranges from 50% to 90%.

In certain embodiments, a water absorption capacity of the porous film is 50 seconds to 150 seconds per 4 centimeters.

Therefore, in the porous film and the method for manufacturing the same provided by the present disclosure, by virtue of using the ternary mixed solvent to dissolve the structural material and the auxiliary structural material, and adding the water into the mixed solution to obtain the film-forming solution, the porous film thus obtained can have a uniform thickness and uniform pores.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for manufacturing a porous film according to one embodiment of the present disclosure;

FIG. 2 is a flowchart of the method for manufacturing the porous film according to another embodiment of the present disclosure;

FIG. 3 is a scanning electron microscope image of the porous film of Example 1;

FIG. 4 is a scanning electron microscope image of the porous film of Comparative Example 1;

FIG. 5 is a scanning electron microscope image of the porous film of Comparative Example 2;

FIG. 6 is a scanning electron microscope image of the porous film of Comparative Example 3;

FIG. 7 is a scanning electron microscope image of the porous film of Comparative Example 4; and

FIG. 8 is a scanning electron microscope image of the porous film of Comparative Example 5.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The present disclosure provides a porous film and a method for manufacturing the same. The porous film has a uniform thickness and a uniform porous structure, which can be applied to a filtering structure or a rapid test structure.

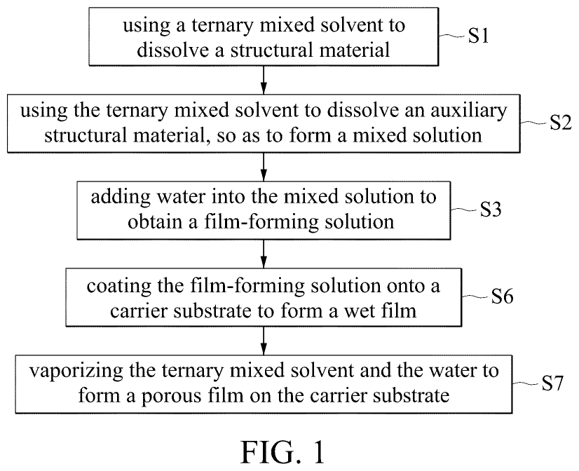

Reference is made to FIG. 1. In the present disclosure, in order to form the uniform porous structure, a ternary mixed solvent is used to dissolve a structural material (step S1), and then to dissolve an auxiliary structural material (step S2), so as to obtain a mixed solution. An appropriate amount of water is added into the mixed solution (step S3), so that a film-forming solution is prepared. The film-forming solution is coated onto a carrier substrate to form a wet film (step S6). Then, the ternary mixed solvent and the water are vaporized at a low-temperature environment (from 40° C. to 90° C.) to form the porous film of the present disclosure on the carrier substrate (step S7).

The porous structure of the porous film is formed after the ternary mixed solvent and the water (hereinafter collectively referred to as a total solvent) are vaporized. That is to say, uniformity of the porous structure, a pore size, and a porosity of the porous film can be affected by an evaporation rate of a solvent and a sequence of vaporizing different solvents. Therefore, components of the solvent and their respective amounts are significant factors in this process.

Apart from the evaporation rate of the solvent and the sequence of vaporizing different solvents, whether or not the ternary mixed solvent is capable of dissolving solid components (i.e., the structural material and the auxiliary structural material) should also be taken into consideration. Since the structural material and the auxiliary structural material do not dissolve in water, it is necessary to consider whether or not the structural material and the auxiliary structural material will be precipitated after the water is added.

In order to provide both the low-temperature vaporizing property and the capability of dissolving the structural material and the auxiliary structural material, a ternary mixed solvent that includes ethanol, isopropanol, and acetone is selected in the present disclosure. The ethanol, the isopropanol, and the acetone are all capable of dissolving the structural material and the auxiliary structural material. In addition, a boiling point of each of the ethanol, the isopropanol, and the acetone is lower than a boiling point of the water.

When a temperature gradually increases, the ethanol, the isopropanol, and the acetone contained in the wet film vaporize in response to corresponding vapor pressures. Due to phase separation caused by vaporization and a cohesive force of water molecules, the water molecules are gradually assembled to form drops. Since the structural material and the auxiliary structural material do not dissolve in water, spaces originally occupied by the drops become the porous structure after the drops are vaporized. In other words, as the ternary mixed solvent is gradually vaporized and the water molecules are gradually assembled, the structural material and the auxiliary structural material also form into the porous structure of the porous film in a gradual manner.

Specifically, based on a total weight of the ternary mixed solvent being 100 phr, an added amount of the ethanol ranges from 28 phr to 38 phr, an added amount of the isopropanol ranges from 25 phr to 42 phr, and an added amount of the acetone ranges from 25 phr to 40 phr.

The structural material and the auxiliary structural material cannot dissolve in water. As such, an added amount of the water affects not only the porous structure of the porous film, but also a solubility of the solid components (i.e., the structural material and the auxiliary structural material). When the added amount of the water is too high, a microscopic structure of the porous film is loose with numerous pores and a larger pore size. As a liquid passes through the porous film, the liquid is retained at the porous film for a shorter length of time. When the added amount of the water is too low, the microscopic structure of the porous film is dense, with fewer or almost no pores therein. As the liquid passes through the porous film, the liquid is retained at the porous film for a longer length of time.

Through controlling a ratio relationship between the added amount of the water and a weight of the structural material, a porous film with a uniform porous structure can be formed. In certain embodiments, the added amount of the water is 0.5 to 5 times the weight of the structural material. Preferably, the added amount of the water is 0.8 to 1.5 times the weight of the structural material. More preferably, the added amount of the water is 0.8 to 1.3 times the weight of the structural material.

In the present disclosure, a solvent system formed by the ternary mixed solvent and the water has a significant influence on the formation of the porous structure of the porous film. Even if the solvent system contains a solvent (water) that has no dissolution capacity, the solid components (i.e., the structural material and the auxiliary structural material) can still be dissolved. In addition, during the process of preparing the film-forming solution, the solid components will not be precipitated.

In certain embodiments, based on a total weight of the total solvent (i.e., the ternary mixed solvent and the water) being 100 phr, the added amount of the ethanol ranges from 25 phr to 32 phr, the added amount of the isopropanol ranges from 20 phr to 40 phr, and the added amount of the acetone ranges from 25 phr to 32 phr.

The solvent system of the present disclosure has a high stability. Even if the film-forming solution has a high solid content (viscosity), a porous film with a good uniformity can still be formed. Generally speaking, the high solid content in the film-forming solution is unfavorable for film formation.

In certain embodiments, the solid content of the film-forming solution is between 5% and 20%. The viscosity of the film-forming solution can be controlled to be between 20 cps and 900 cps. Since one specific ternary mixed solvent is used in the present disclosure, even if the viscosity of the film-forming solution is above 300 cps, a porous film with a good uniformity can still be formed.

In the present disclosure, the structural material is selected from the group consisting of nitrocellulose, polyvinylidene fluoride (PVDF), polysulfone, and any combination thereof. The auxiliary structural material is selected from the group consisting of cellulose acetate, polylactic acid, poly(lactic-co-glycolic acid) (PLGA), poly-(D)glucosamine, and any combination thereof. An addition of the auxiliary structural material aids the structural material in forming the porous film. Accordingly, the porous structure of the porous film has a high stability and a good continuity.

In certain embodiments, based on a total weight of the film-forming solution being 100 phr, an amount of the structural material ranges from 5 phr to 15 phr, and an amount of the auxiliary structural material ranges from 0.5 phr to 5 phr. Specifically, a weight amount of the structural material is 8 to 15 times a weight amount of the auxiliary structural material.

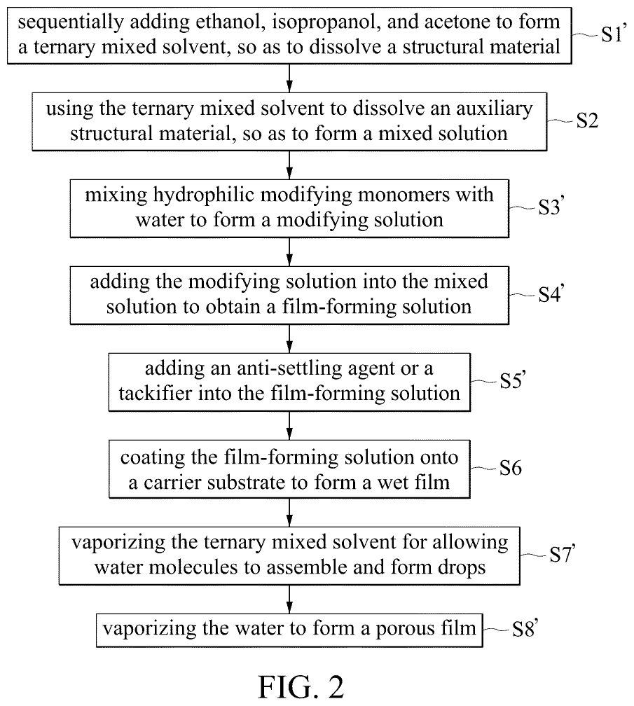

Reference is made to FIG. 2. In certain embodiments, the step of using the ternary mixed solvent to dissolve the structural material includes: sequentially adding the ethanol, the isopropanol, and the acetone to form the ternary mixed solvent, so as to dissolve the structural material (step S1′). In this way, the ternary mixed solvent can achieve a most satisfactory dissolution effect.

In certain embodiments, a hydrophilic material is added into the film-forming solution. An addition of the hydrophilic material can improve hydrophilicity of a surface of the porous film A treatment to modify the hydrophilicity of the porous film can adjust the capillary performance of the film. The treatment includes, but is not limited to, adding hydrophilic materials (such as polymer) by way of either graft-to or graft-from modification of the polymer, surface modification by plasma, surface coating, etc.

Referring to FIG. 2, after the mixed solution is formed (step S2), the hydrophilic material can be mixed with the water to form a modifying solution (step S3′). Then, the modifying solution is added into the mixed solution (i.e., the ternary mixed solvent, the structural material, and the auxiliary structural material), so as to obtain the film-forming solution (step S4′). That is to say, through the step of adding the modifying solution, the effect of simultaneously adding the water and the hydrophilic material can be achieved.

To be more specific, a hydrophilic modifying material can include a monomer, a polymer, or a surfactant.

The polymer can be, for example, an electrically neutral polymer, a negative salt polymer with positive or negative charges, or a zwitterionic polymer. For example, the electrically neutral polymer can be polyethylene glycol (PEG) or polyethylene oxide (PEO), or can be poly(2-hydroxyethyl methacrylate) (pHEMA). The negative salt polymer with positive or negative charges can be quaternary ammonium cations or deprotonated carboxylate and its derivatives. The zwitterionic polymer can be poly (sulfobetaine methacrylate) p(SBMA), poly (carboxybetaine methacrylate) p(CBMA), or 2-methacryloyloxyethyl phosphorylcholine (MPC) or its derivatives.

For example, the surfactant can be sodium dodecyl sulfate, sodium tetradecyl sulfate, sodium cetearyl sulfate, sodium n-octadecyl sulfate, hexadecyltrimethylammonium bromide, or any combination thereof.

In certain embodiments, based on the total weight of the film-forming solution being 100 phr, an amount of the water ranges from 3 phr to 20 phr, and an amount of the hydrophilic material ranges from 0.01 phr to 0.5 phr.

It should be noted that the action of adding the hydrophilic material is not limited to taking place before the process of coating the film-forming solution to form the wet film After the porous film is formed (step S8′), the porous film can be immersed in a solution containing the hydrophilic material, so as to achieve the effect of enhancing and stabilizing the hydrophilicity of the surface of the porous film.

In certain embodiments, an anti-settling agent or a tackifier can be added into the film-forming solution. By adding the anti-settling agent and the tackifier, a stability of the film-forming solution can be enhanced, such that the porous structure of the porous film can be improved. Specifically, the porous film of the present disclosure has a good thickness uniformity (less than or equal to ±10%), and the porous structure has a good continuity.

Referring to FIG. 2, after the film-forming solution is obtained (step S3′ or step S4′), the anti-settling agent or the tackifier can be added into the film-forming solution (step S5′), and the film-forming solution is coated onto the carrier substrate to form the wet film (step S6).

The anti-settling agent can include: organic bentonite, hydrogenated castor oil, polyamide wax, titanate coupling agents, or any combination thereof.

The tackifier can include: C5 petroleum resins, terpene phenol resins, terpene-styrene resins, hydrogenated glycerol ester resins, or any combination thereof.

In certain embodiments, through controlling the temperature, the porous film of the present disclosure can be manufactured by vaporizing the ternary mixed solvent before the water during a solvent evaporation process.

Reference is made to FIG. 2. After the wet film is formed (step S6), a portion of the ternary mixed solvent is vaporized at a temperature from 40° C. to lower than 50° C., so that the water molecules are assembled by phase separation to form the drops (step S7′). Then, another portion of the ternary mixed solvent and the water are vaporized at a temperature from 50° C. to 65° C., so as to form the porous film of the present disclosure (step S8′).

In certain embodiments, in the step S7′, 60 wt % to 80 wt % of the total solvent is vaporized at a temperature from 40° C. to lower than 50° C. In this way, the effect of controlling the porous structure of the porous film can be achieved. Further, during the process of vaporizing the ternary mixed solvent and the water (step S7′ and step S8′), air can be simultaneously drawn out.

In certain embodiments, the carrier substrate is a polyethylene terephthalate (PET) film, a poly(ethylene) (PE) film, a poly(propylene) (PP) film, an aluminum (Al) foil, or a substrate that carries the same, and the porous film is formed on the carrier substrate. In other embodiments, the carrier substrate is a release film (e.g., a PET release film, a PE release film, a PP release film, or an Al foil release film). After the porous film is manufactured according to the method as illustrated in FIG. 1 or FIG. 2, the porous film is separated from the carrier substrate. It should be noted that compared with conventional porous films currently available on the market, the porous film of the present disclosure has an improved elasticity and thus has a wider range of application.

### Experimental Results

In order to prove that the porous structure of the porous film provided by the present disclosure has a good uniformity, porous films of Examples 1 to 2 and Comparative Examples 1 to 6 are manufactured according to the above-mentioned steps (a thickness of a dry film is 100 micrometers, and a thickness of the wet film ranges from 600 micrometers to 1,400 micrometers). The difference between Examples 1 to 2 and Comparative Examples 1 to 6 resides in that an amount of each component in the film-forming solution is different. Specific component amounts in the film-forming solution are shown in Table 1, and the viscosity of the film-forming solution is also listed in Table 1.

According to contents in Table 1, a ratio between the added amount of the water and the weight of the structural material in the film-forming solution (i.e., water/structural material for short in Table 2) is calculated, and the total weight of the ternary mixed solvent and the total weight of the total solvent are calculated (as listed in Table 2). According to the contents in Table 1, an amount of the acetone, an amount of the ethanol, and an amount of the isopropanol are calculated based on the ternary mixed solvent or the total solvent (100 phr), and results thereof are listed in Table 2.

The porous films of Examples 1 to 2 and Comparative Examples 1 to 6 are measured in terms of average pore size, porosity, and thickness uniformity. A water absorption and capillary flow test is also conducted on these porous films. Specific results thereof are listed in Table 3.

The average pore size and the porosity of the porous film are calculated by use of an image processing program (ImageJ). The thickness uniformity of the porous film is measured by use of an optical thickness tester (the model LZ-990 produced by Kett Electric Laboratory Co., Ltd.). The water absorption and capillary flow test is conducted by placing a dry porous film in a flat manner, dripping deionized water onto one end of the porous film, and measuring a length of time that the porous film takes to absorb water for a length of 4 centimeters.

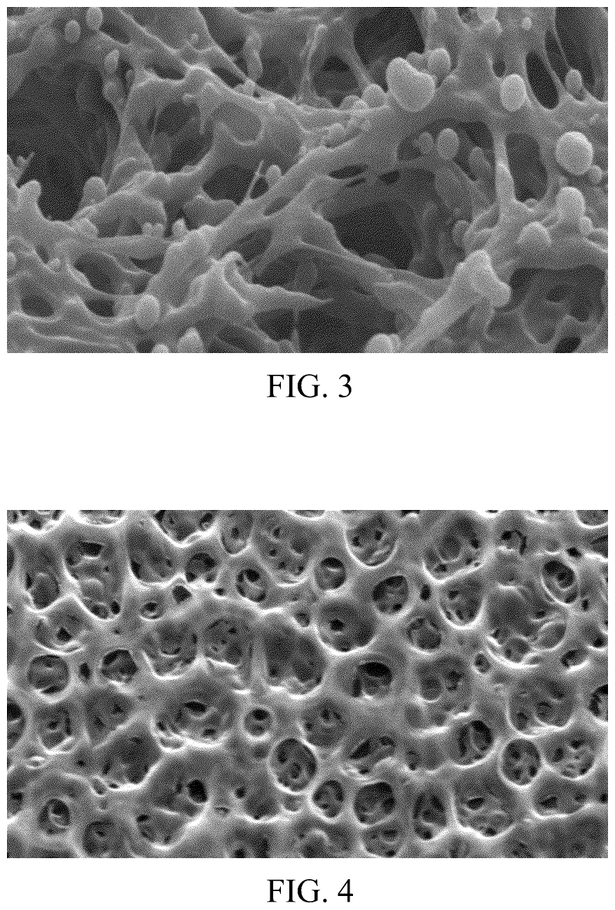

As sequentially shown from FIG. 3 to FIG. 8, the porous film of Example 1 (FIG. 3) and the porous films of Comparative Examples 1 to 5 (FIG. 4 to FIG. 8) are observed by use of a scanning electron microscope (SEM).

TABLE 1

| (phr) | Example 1 | Example 2 |
|---|---|---|
| Structural material | 9 | 13.5 |
| Auxiliary Structural material | 1 | 1.5 |
| Water | 9.5 | 15 |
| Acetone | 25 | 25 |
| Ethanol | 25 | 25 |
| Isopropanol | 30 | 19.5 |
| Hydrophilic material | 0.1 | 0.1 |
| Tackifier | 0.2 | 0.2 |
| Anti-settling agent | 0.2 | 0.2 |
| Viscosity of film-forming solution (cps) | 350 | 400 |

| | Comparative | Comparative | Comparative | Comparative | Comparative | Comparative |
|---|---|---|---|---|---|---|
| (phr) | Example 1 | Example 2 | Example 3 | Example 4 | Example 5 | Example 6 |
| Structural | 9 | 9 | 14 | 9 | 9 | 13.5 |
| material | | | | | | |
| Auxiliary | 1 | — | 1 | 1 | 1 | 1.5 |
| Structural | | | | | | |
| material | | | | | | |
| Water | 14.5 | 9.5 | 9.5 | 4.5 | 9 | 15 |
| Acetone | 25 | 26 | 25 | 30 | 15 | 25 |
| Ethanol | 25 | 25 | 25 | 25 | 10 | 25 |
| Isopropanol | 25 | 30 | 35 | 30 | 55 | 19.9 |
| Hydrophilic | 0.1 | 0.1 | 0.1 | 0.1 | 0.1 | 0.1 |
| material | | | | | | |
| Tackifier | 0.2 | 0.2 | 0.2 | 0.2 | 0.2 | — |
| Anti-settling | 0.2 | 0.2 | 0.2 | 0.2 | 0.2 | — |
| agent | | | | | | |
| Viscosity of | 300 | 320 | 405 | 600 | 305 | 50 |
| film-forming | | | | | | |
| solution (cps) | | | | | | |

TABLE 2

| (phr) | Example 1 | Example 2 |
|---|---|---|
| Water/structural material | 1.06 | 1.11 |
| Total weight of ternary mixed solvent | 80 | 69.5 |
| Total weight of total solvent | 89.5 | 84.5 |

| | | | |
|---|---|---|---|
| Based on ternary mixed solvent | Acetone | 31.25 | 35.97 |
| | Ethanol | 31.25 | 35.97 |
| | Isopropanol | 37.50 | 28.06 |
| Based on total solvent | Acetone | 27.93 | 29.59 |
| | Ethanol | 27.93 | 29.59 |
| | Isopropanol | 33.52 | 23.08 |

| | | Comparative | Comparative | Comparative | Comparative | Comparative | Comparative |
|---|---|---|---|---|---|---|---|
| (phr) | | Example 1 | Example 2 | Example 3 | Example 4 | Example 5 | Example 6 |
| Water/structural material | | 1.61 | 1.06 | 0.68 | 0.50 | 1.06 | 1.11 |
| Total weight of ternary | | 75 | 81 | 85 | 85 | 80 | 69.5 |
| mixed solvent | | | | | | | |
| Total weight of total | | 89.5 | 90.5 | 94.5 | 89.5 | 89.5 | 84.5 |
| solvent | | | | | | | |
| Based on | Acetone | 33.33 | 32.10 | 29.41 | 35.29 | 18.75 | 35.97 |
| ternary | Ethanol | 33.33 | 30.86 | 29.41 | 29.41 | 12.50 | 35.97 |
| mixed | Isopropanol | 33.33 | 37.04 | 41.18 | 35.29 | 68.75 | 28.06 |
| solvent | | | | | | | |
| Based on | Acetone | 27.93 | 28.73 | 26.46 | 33.52 | 16.76 | 29.59 |
| total | Ethanol | 27.93 | 27.62 | 26.46 | 27.93 | 11.17 | 29.59 |
| solvent | Isopropanol | 27.93 | 33.15 | 37.04 | 33.52 | 61.45 | 23.08 |

TABLE 3

| | Example 1 | Example 2 |
|---|---|---|
| Pore size (micrometer) | 10 | 10 |
| Porosity | 77.2% | 76.8% |
| Water absorption capacity (sec/4 centimeters) | 90 | 90 |
| Thickness uniformity | ±10% | ±10% |
| Capillary flow evaluation | capillary flow speed stable | capillary flow speed stable |

| | Comparative | Comparative | Comparative | Comparative | Comparative | Comparative |
|---|---|---|---|---|---|---|
| | Example 1 | Example 2 | Example 3 | Example 4 | Example 5 | Example 6 |
| Pore size | 3 | 3 | 4 | 2 | 6 | 9 |
| (micrometer) | | | | | | |
| Porosity | 80.5% | 77.8% | 72.8% | 55.3% | 88.5% | 79.8% |
| Water | 50 | 65 | 110 | 250 | 45 | 80 |
| absorption | | | | | | |
| capacity | | | | | | |
| (sec/4 | | | | | | |
| centimeters) | | | | | | |
| Thickness | ±10% | ±10% | ±10% | ±10% | ±10% | ±30% |
| uniformity | | | | | | |
| Capillary | capillary | capillary | capillary | capillary | capillary | capillary |
| flow | flow speed | flow speed | flow speed | flow speed | flow speed | flow speed |
| evaluation | too fast | unstable | unstable | too slow | too fast | unstable |
| | and | | | | and | due to non- |
| | divergent | | | | divergent | uniform |
| | | | | | | thickness |

From Table 1 to Table 3, it can be observed that by using the ternary mixed solvent in the present disclosure, a porous film with a uniform thickness and uniform pores (the thickness uniformity being less than or equal to ±10%) can still be formed (as shown in FIG. 3) even if the viscosity of the film-forming solution is high (greater than or equal to 300 cps). However, the viscosity of the film-forming solution is not limited thereto. Further, a flow speed of the porous film is stable during the capillary flow test. A capillary flow speed can be controlled by the porosity and the pore size of the porous film.

In Comparative Example 1, the ratio between the added amount of the water and the weight of the structural material in the film-forming solution is high. As a result, the microscopic structure of the porous film is loose with numerous pores and a higher porosity (as shown in FIG. 4). As a liquid passes through the porous film, the liquid is retained at the porous film for a longer length of time.

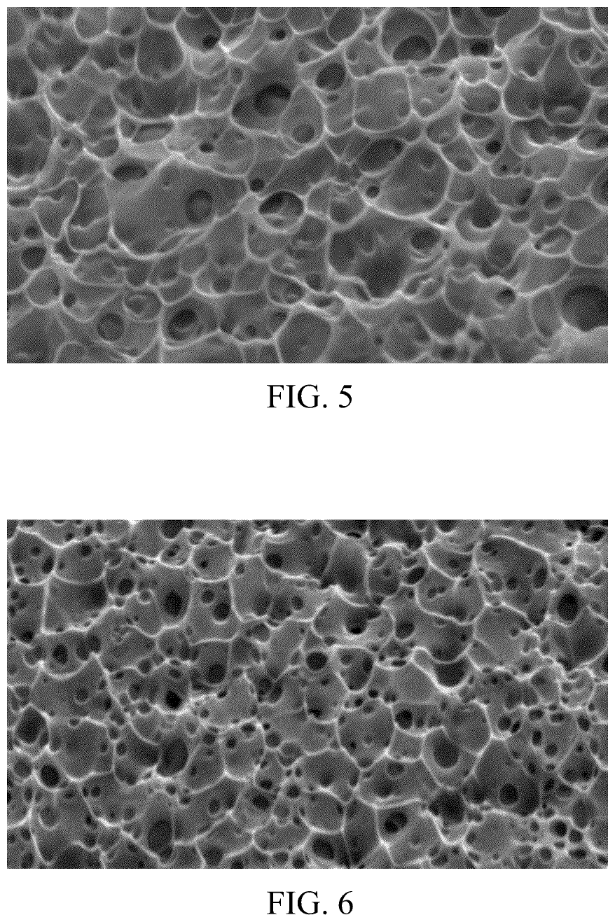

In Comparative Example 2, without adding the auxiliary structural material, a structural continuity of the porous film is poor (as shown in FIG. 5). The flow speed of the porous film is unstable during the capillary flow test.

In Comparative Example 3, an added amount of the structural material is high, which causes the structure of the porous film to be dense. However, the structural continuity of the porous film is not improved (as shown in FIG. 6). The flow speed of the porous film is unstable during the capillary flow test.

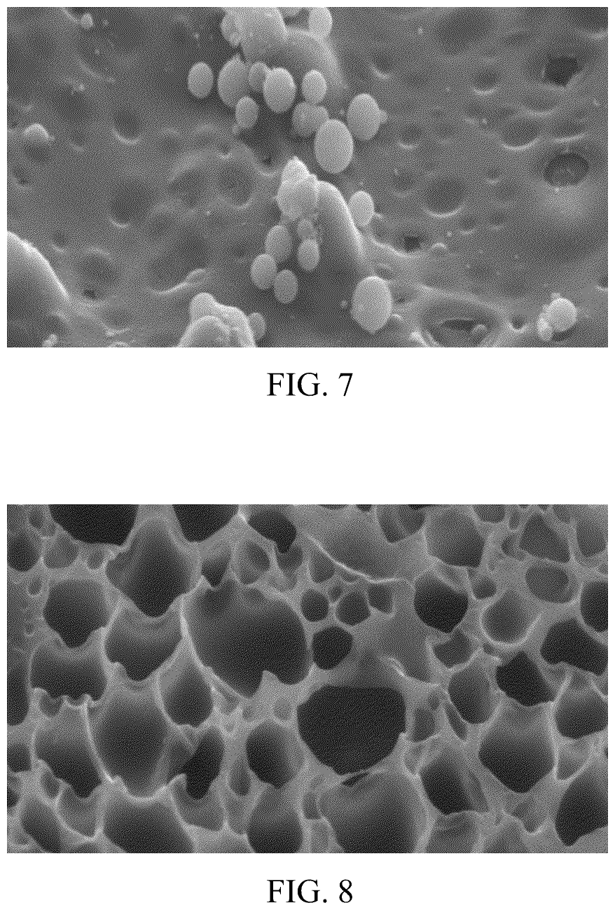

In Comparative Example 4, the ratio between the added amount of the water and the weight of the structural material in the film-forming solution is low. As a result, the microscopic structure of the porous film is so dense as to have almost no pores (as shown in FIG. 7). The flow speed of the porous film is extremely slow during the capillary flow test.

In Comparative Example 5, the amount of the isopropanol in the ternary mixed solvent is high while the amounts of the acetone and the ethanol are low, such that an evaporation speed of the solvent is affected. Since the evaporation speed of the ternary mixed solvent is slow, the water molecules have already assembled and formed into larger drops before being vaporized. As such, the pores formed in the porous film are numerous in quantity and large in size (as shown in FIG. 8). The flow speed of the porous film is fast and unstable during the capillary flow test.

In Comparative Example 6, without adding the tackifier and the anti-settling agent, the thickness uniformity of the porous film is negatively affected.

### Beneficial Effects of the Embodiments

In conclusion, in the porous film and the method for manufacturing the same provided by the present disclosure, by virtue of using the ternary mixed solvent to dissolve the structural material and the auxiliary structural material, and adding the water into the mixed solution to obtain the film-forming solution, the porous film thus obtained can have a uniform thickness and uniform pores.

More specifically, by virtue of sequentially adding the ethanol, the isopropanol, and the acetone to form the ternary mixed solvent, the structural material and the auxiliary material structure can have a good solubility and are not easily precipitated.

More specifically, by virtue of the added amount of the water being 0.5 to 5 times the weight of the structural material, the porous film can have an appropriate porosity, an appropriate pore size, and a good structural continuity.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for manufacturing a porous film, comprising:
using a ternary mixed solvent to dissolve a structural material and an auxiliary structural material, so as to obtain a mixed solution; wherein, based on a total weight of the ternary mixed solvent being 100 phr, the ternary mixed solvent includes 28 phr to 38 phr of ethanol, 25 phr to 42 phr of isopropanol, and 25 phr to 40 phr of acetone; wherein the structural material is selected from the group consisting of nitrocellulose, polyvinylidene fluoride, polysulfone, and any combination thereof; wherein the auxiliary structural material is selected from the group consisting of cellulose acetate, polylactic acid, poly(lactic-co-glycolic acid), poly-(D)glucosamine, and any combination thereof;
adding water into the mixed solution to obtain a film-forming solution;
coating the film-forming solution onto a carrier substrate to form a wet film; and
vaporizing the ternary mixed solvent and the water to form the porous film on the carrier substrate.

2. The method according to claim 1, wherein the step of using the ternary mixed solvent to dissolve the structural material includes: sequentially adding the ethanol, the isopropanol, and the acetone to form the ternary mixed solvent.

3. The method according to claim 1, wherein an added amount of the water is 0.5 to 5 times a weight of the structural material.

4. The method according to claim 1, wherein the step of vaporizing the ternary mixed solvent and the water includes: vaporizing a portion of the ternary mixed solvent at a temperature from 40° C. to lower than 50° C., so that water molecules are assembled by phase separation to form drops; and vaporizing another portion of the ternary mixed solvent and the water at a temperature from 50° C. to 65° C., so as to form the porous film.

5. The method according to claim 4, wherein a total solvent includes the ternary mixed solvent and the water; wherein, based on a total weight of the total solvent being 100 wt %, 60 wt % to 80 wt % of the total solvent is vaporized at a temperature from 40° C. to lower than 50° C.

6. The method according to claim 1, wherein, based on a total weight of the ternary mixed solvent and the water being 100 phr, an added amount of the ethanol ranges from 25 phr to 32 phr, an added amount of the isopropanol ranges from 20 phr to 40 phr, and an added amount of the acetone ranges from 25 phr to 32 phr.

7. The method according to claim 1, wherein the step of adding the water into the mixed solution includes: mixing a hydrophilic material with the water to form a modifying solution, and then adding the modifying solution into the mixed solution.

8. The method according to claim 1, wherein a viscosity of the film-forming solution ranges from 150 cps to 900 cps.

9. The method according to claim 1, wherein, based on a total weight of the film-forming solution being 100 phr, an amount of the structural material ranges from 5 phr to 15 phr, an amount of the auxiliary structural material ranges from 0.5 phr to 5 phr, an amount of the ternary mixed solvent ranges from 80 phr to 95 phr, and an amount of the water ranges from 5 phr to 18 phr.

10. The method according to claim 1, wherein the carrier substrate is a polyethylene terephthalate film, a poly(ethylene) film, a poly(propylene) film, an aluminum foil, or a substrate that carries the same.

11. The method according to claim 1, wherein the carrier substrate is a polyethylene terephthalate release film, a poly(ethylene) release film, a poly(propylene) release film, or an aluminum foil release film, the method further comprising: separating the porous film from the carrier substrate after the porous film is formed.

12. A porous film, characterized in that the porous film is manufactured by the method as claimed in claim 1, and a thickness uniformity of the porous film is less than or equal to ±10%.

13. The porous film according to claim 12, wherein a pore size of the porous film is between 2 micrometers and 20 micrometers.

14. The porous film according to claim 12, wherein a porosity of the porous film ranges from 50% to 90%.

15. The porous film according to claim 12, wherein a water absorption capacity of the porous film is 50 seconds to 150 seconds per 4 centimeters.
